(19) United States
(12) Patent Application Publication
(10) Pub. No.: US 2018/0319640 A1
(43) Pub. Date: Nov. 8, 2018

(54) Distance Measuring System

(71) Applicant: Eric Flenoid, Brentwood, CA (US)

(72) Inventor: Eric Flenoid, Brentwood, CA (US)

(21) Appl. No.: 15/584,418

(22) Filed: May 2, 2017

(51) Int. Cl. B66F 9/075; G01C 3/06; G01C 3/18; G01C 3/30

(52) U.S. Cl. CPC B66F 9/0755; G01C 3/30; G01C 3/18; G01C 3/06

(57) ABSTRACT

A distance measuring system for determining distance between a vehicle and an object includes a container that has a pair of slots. A vehicle is included that has a pair of forks and the pair of forks are selectively positioned between a lifted position and a lowered position. The vehicle is selectively driven toward the container having each of the forks extending into an associated one of the slots. In this way the vehicle may lift the container. A measuring unit is coupled to the forks and the measuring unit is in electrical communication with the vehicle. The measuring unit emits a first signal between the forks and the container to communicate a distance between the forks and the container to a driver. The measuring unit emits a second signal between the forks and the ground. In this way the measuring unit may communicate a height of the forks with respect to ground to the driver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to measuring devices and more particularly pertains to a new measuring device for determining distance between a vehicle and an object.

### BRIEF SUMMARY OF THE INVENTION

An embodiment of the disclosure meets the needs presented above by generally comprising a container that has a pair of slots. A vehicle is included that has a pair of forks and the pair of forks are selectively positioned between a lifted position and a lowered position. The vehicle is selectively driven toward the container having each of the forks extending into an associated one of the slots. In this way the vehicle may lift the container. A measuring unit is coupled to the forks and the measuring unit is in electrical communication with the vehicle. The measuring unit emits a first signal between the forks and the container to communicate a distance between the forks and the container to a driver. The measuring unit emits a second signal between the forks and the ground. In this way the measuring unit may communicate a height of the forks with respect to ground to the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of measuring unit of a distance measuring system according to an embodiment of the disclosure.

FIG. 2 is a back view of a housing of an embodiment of the disclosure.

FIG. 3 is a front view of housing of an embodiment of the disclosure.

FIG. 4 is a perspective in-use view of an embodiment of the disclosure.

FIG. 5 is a schematic view of an embodiment of the disclosure.

### DETAILED DESCRIPTION OF THE INVENTION

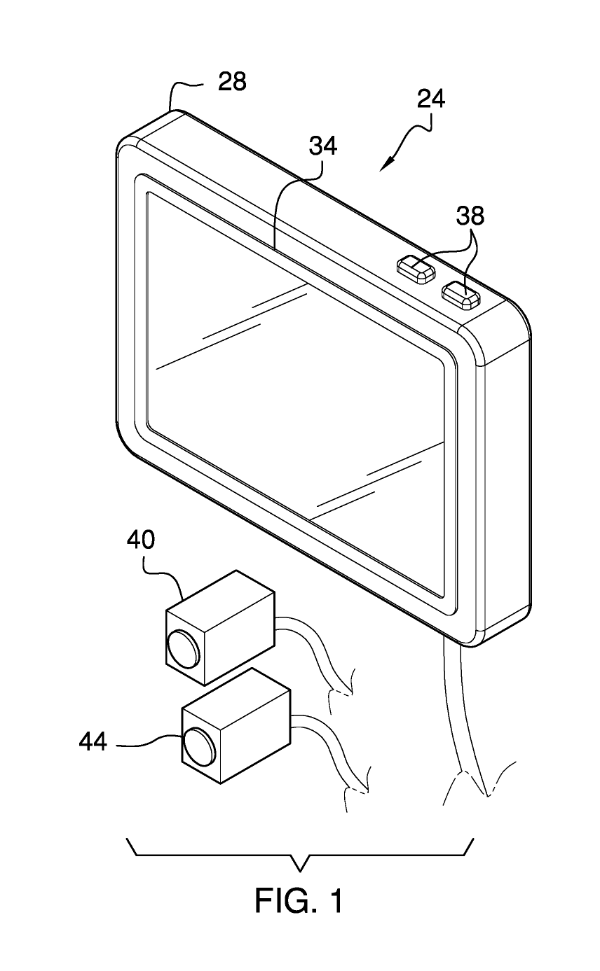

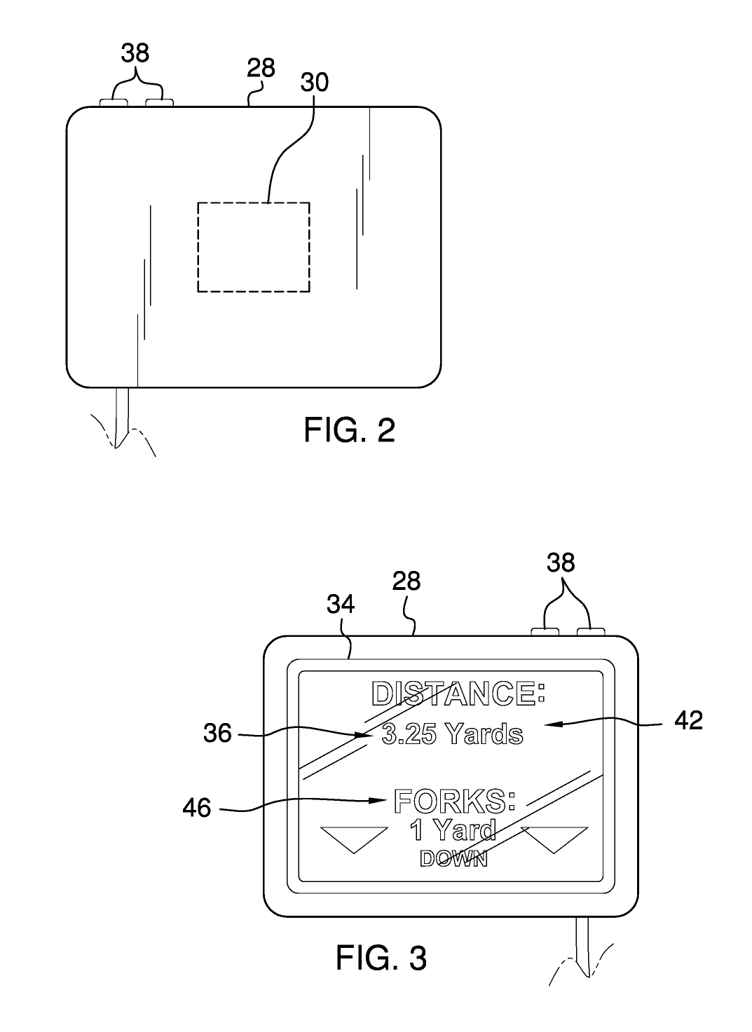

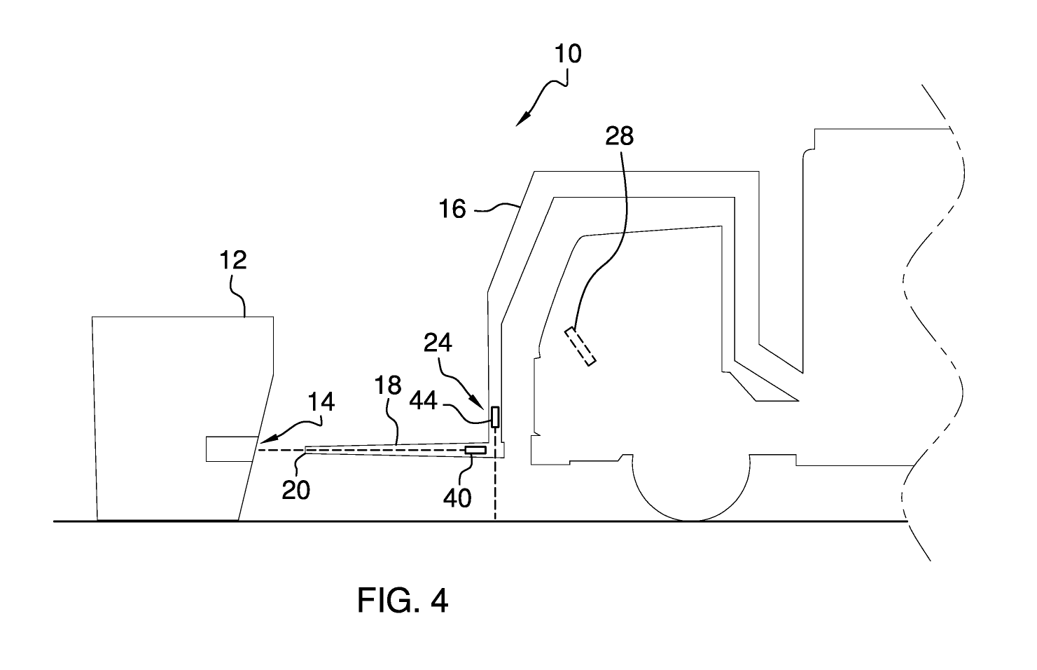

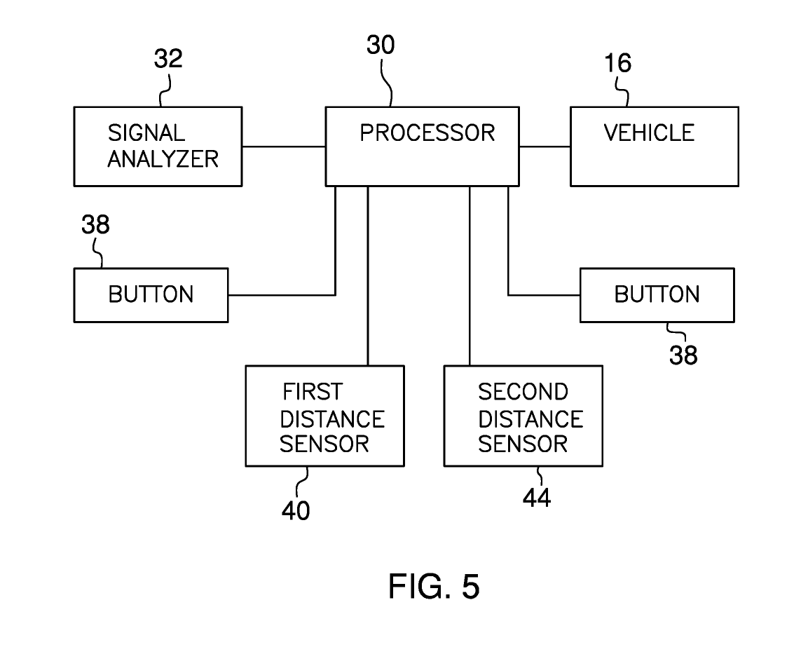

With reference now to the drawings, and in particular to FIGS. 1 through 5 thereof, a new measuring device embodying the principles and concepts of an embodiment of the disclosure and generally designated by the reference numeral 10 will be described.

As best illustrated in FIGS. 1 through 5, the distance measuring system 10 generally comprises a container 12 that has a pair of slots 14. The container 12 may be a commercial garbage dumpster or the like. A vehicle 16 is included that has a pair of forks 18 and the pair of forks 18 are selectively positioned between a lifted position and a lowered position. The vehicle 16 is selectively driven toward the container 12 having each of the forks 18 extending into an associated one of the slots 14. In this way the vehicle 16 lifts the container 12. The vehicle 16 may be a commercial garbage truck or the like and contents in the container 12 may be dumped into the vehicle 16 for waste management.

A measuring unit 24 is provided and the measuring unit 24 is coupled to the forks 18. Additionally, the measuring unit 24 is in electrical communication with the vehicle 16. The measuring unit 24 emits a first signal between the forks 18 and the container 12. In this way the measuring unit 24 communicates a distance between the forks 18 and the container 12 to a driver. The measuring unit 24 emits a second signal to communicate a height of the forks 18 with respect to ground 26 to the driver. In this way the measuring unit 24 facilitates the driver to align the forks 18 with the slots 14 in the container 12.

The measuring unit 24 comprises a housing 28 that is positioned within the vehicle 16 such that the housing 28 is accessible to the driver. A processor 30 is coupled to the housing 28 and the processor 30 is electrically coupled to the vehicle 16 as a power source. The processor 30 may be an electronic processor 30 or the like. A signal analyzer 32 is coupled to the housing 28 and the signal analyzer 32 is electrically coupled to the processor 30. The signal analyzer 32 may be a Doppler signal analyzer, a laser strength analyzer or any other electronic signal analyzer capable of determining relative distance between two objects.

A display 34 is provided and the display 34 is coupled to the housing 28 such that the display 34 is visible to the driver. The display 34 displays indicia 36 and the display 34 is electrically coupled to the processor 30. Moreover, the display 34 may be an LCD or the like. A plurality of buttons 38 is provided and each of the buttons 38 is movably coupled to the housing 28. Each of the buttons 38 is electrically coupled to the processor 30 to control operational parameters of the processor 30.

A first distance sensor 40 is provided and the first distance sensor 40 is coupled to the forks 18. The first distance sensor 40 emits the first signal forwardly from the associated fork 18. The first signal reflects off of the container 12 back to the first distance sensor 40. The first distance sensor 40 is in electrical communication with the processor 30 and the signal analyzer 32. In this way the signal analyzer 32 determines a distance between the distal end 20 of the associated fork 18 and the container 12. The first distance sensor 40 may be a radio frequency transmitter, a laser light transmitter or any other electronic distance measuring sensor. The display 34 selectively displays first indicia 42. The first indicia 42 may comprise words and numbers corresponding to the distance between the associated fork 18 and the container 12.

A second distance sensor 44 is provided and the second distance sensor 44 is coupled to the associated fork 18. The second distance sensor 44 emits the second signal downwardly from the associated fork 18. Additionally, the second signal reflects off of ground 26 back to the second distance sensor 44. The second distance sensor 44 is in electrical communication with the processor 30 and the signal analyzer 32. In this way the signal analyzer 32 determines a distance between the bottom surface 22 of the associated fork and the ground 26. The second distance sensor 44 may be a radio frequency transmitter, a laser light transmitter or any other distance measuring electronic sensor. The display 34 displays second indicia 46. The second indicia 46 may comprise words and numbers corresponding to the distance between the associated fork 18 and the ground 26. Each of the first 40 and second 44 distance sensors may be in electrical communication with the processor 30 through any conventional means to include, but not be limited to, hardwire communication or wireless communication involving a transmitter and a receiver.

In use, the vehicle 16 is driven toward the container 12 and the buttons 38 are manipulated to turn each of the first 40 and second 44 distance sensors on. The first distance sensor 40 emits the first signal and the display 34 displays the distance between the distal end 20 of the associated fork 18 and the container 12. In this way the driver is alerted to the distance between the associated fork 18 and the container 12. The second distance sensor 44 emits the second signal and the display 34 displays the height of the associated fork 18 with respect to ground 26. In this way the driver is facilitated to match the height of the forks 18 to the height of the slots 14 in the container 12. In this manner the measuring unit 24 enhances efficiency and accuracy with respect to engaging the forks 18 in the slots 14 and emptying the container 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A distance measuring system being configured to determine a distance between a fork lift and an object to be lifted, said system comprising:
a container having a pair of slots;
a vehicle having a pair of forks, said pair of forks being selectively positioned between a lifted position and a lowered position, said vehicle being selectively driven toward said container having each of said forks extending into an associated one of said slots thereby facilitating said vehicle to lift said container; and
a measuring unit being coupled to said forks, said measuring unit being in electrical communication with said vehicle, said measuring unit emitting a first signal between said forks and said container wherein said measuring unit is configured to communicate a distance between said forks and said container to a driver, said measuring unit emitting a second signal between said forks and the ground wherein said measuring unit is configured to communicate a height of said forks to the driver.

2. The system according to claim 1, wherein said measuring unit comprises a housing being positioned within said vehicle wherein said housing is configured to be accessible to the driver.

3. The system according to claim 2, further comprising a processor being coupled to said housing, said processor being electrically coupled to said vehicle as a power source.

4. The system according to claim 3, further comprising a signal analyzer being coupled to said housing, said signal analyzer being electrically coupled to said processor.

5. The system according to claim 3, further comprising a display being coupled to said housing wherein said display is configured to be visible to the driver, said display displaying indicia, said display being electrically coupled to said processor.

6. The system according to claim 3, further comprising a plurality of buttons, each of said buttons being movably coupled to said housing wherein each of said buttons is configured to be manipulated, each of said buttons being electrically coupled to said processor such that said plurality of buttons controls operational parameters of said processor.

7. The system according to claim 1, further comprising a first distance sensor being coupled to an associated one of said forks, said first distance sensor emitting said first signal, said first signal being emitted forwardly from said associated fork and reflecting off of said container back to said first distance sensor.

8. The system according to claim 7, wherein:
said measuring unit includes a processor, a signal analyzer and a display; and
said first distance sensor is in electrical communication with said processor such that said signal analyzer determines a distance between said associated fork and said container, said display displaying indicia corresponding to said distance between said associated fork and said container.

9. The system according to claim 1, further comprising a second distance sensor being coupled to said associated fork, said second distance sensor emitter said second signal, said second signal being emitted downwardly from said associated fork and reflecting off of ground back to said second distance sensor.

10. The system according to claim 9, wherein:
said measuring unit includes a processor, a signal analyzer and a display; and
said second distance sensor is in electrical communication with said processor such that said signal analyzer determines a distance between said associated fork and the ground, said display displaying indicia corresponding to said distance between said associated fork and the ground.

11. A distance measuring system being configured to determine a distance between a fork lift and an object to be lifted, said system comprising:
a container having a pair of slots;
a vehicle having a pair of forks, said pair of forks being selectively positioned between a lifted position and a lowered position, said vehicle being selectively driven toward said container having each of said forks extending into an associated one of said slots thereby facilitating said vehicle to lift said container; and
a measuring unit being coupled to said forks, said measuring unit being in electrical communication with said vehicle, said measuring unit emitting a first signal between said forks and said container wherein said measuring unit is configured to communicate a distance between said forks and said container to a driver, said measuring unit emitting a second signal between said forks and the ground wherein said measuring unit is configured to communicate a height of said forks to the driver, said measuring unit comprising:
a housing being positioned within said vehicle wherein said housing is configured to be accessible to the driver,
a processor being coupled to said housing, said processor being electrically coupled to said vehicle as a power source,
a signal analyzer being coupled to said housing, said signal analyzer being electrically coupled to said processor,
a display being coupled to said housing wherein said display is configured to be visible to the driver, said display displaying indicia, said display being electrically coupled to said processor,
a plurality of buttons, each of said buttons being movably coupled to said housing wherein each of said buttons is configured to be manipulated, each of said buttons being electrically coupled to said processor such that said plurality of buttons controls operational parameters of said processor,
a first distance sensor being coupled to an associated one of said forks, said first distance sensor emitting said first signal, said first signal being emitted forwardly from said associated fork and reflecting off of said container back to said first distance sensor, said first distance sensor being in electrical communication with said processor such that said signal analyzer determines a distance between said associated fork and said container, said display displaying indicia corresponding to said distance between said associated fork and said container, and
a second distance sensor being coupled to said associated fork, said second distance sensor emitter said second signal, said second signal being emitted downwardly from said associated fork and reflecting off of ground back to said second distance sensor, said second distance sensor being in electrical communication with said processor such that said signal analyzer determines a distance between said associated fork and the ground, said display displaying indicia corresponding to said distance between said associated fork and the ground.
